(19) United States
(12) Patent Application Publication
(10) Pub. No.: US 2024/0420252 A1
(43) Pub. Date: Dec. 19, 2024

(54) MASHUPS IN FEATURED STORIES

(71) Applicant: Snap Inc., Santa Monica, CA (US)

(72) Inventors: Nathan Kenneth Boyd, Los Angeles, CA (US); Marc Brown, New York, NY (US); Shuaiqing Luo, Los Angeles, CA (US); Wenjie Ma, Los Angeles, CA (US); Rasana Manandhar, Draper, UT (US); Anton Shevchenko, Black Diamond, WA (US); Alexander Vodovoz, inglewood, CA (US); Yilin Yang, Bellevue, WA (US)

(21) Appl. No.: 18/485,747

(22) Filed: Oct. 12, 2023

Related U.S. Application Data
(60) Provisional application No. 63/508,790, filed on Jun. 16, 2023.

(51) Int. Cl. G06Q 50/00; G06F 3/0482; G06T 7/20; G06V 20/40; G06V 40/16

(52) U.S. Cl. CPC G06Q 50/01; G06F 3/0482; G06T 7/20; G06V 20/46; G06V 40/174

(57) ABSTRACT

A technique for deriving a mashup is described. Given a collection of media content items for sequential playback, a subset of the media content items are selected for inclusion in a mashup, based on selection criteria specified in a template associated with the featured story. The subset of media content items are then arranged in a mashup, which is prepended to the story. By automatically generating a mashup—an abbreviated version of a story—the mashup will increase user engagement and encourage sharing, because the mashup condenses the content into a more digestible and captivating format. By using optimized content selection criteria, the mashup will include only the best and most impactful moments, highlights, or key elements of the story. The shorter version grabs the viewer's attention, maintaining their interest and prompting them to share the condensed experience with others, enticing them to discover the full story.

### RELATED APPLICATIONS

This application claims the benefit of and priority to U.S. Provisional Patent Application No. 63/508,790, filed on Jun. 16, 2023, the entire contents of which are incorporated herein by reference.

### TECHNICAL FIELD

The present disclosure relates to automated techniques for generating condensed digital multimedia previews by selectively extracting representative constituent media elements from a larger media collection and combining them into a cohesive abbreviated version, leveraging computerized analysis of media characteristics and user engagement metrics.

### BACKGROUND

The prevalence of mobile phones with mobile apps for capturing photos and videos, and creating multimedia messages and memories, has become a common phenomenon. It can be attributed to the convenience and portability of mobile devices, which allow users to capture spontaneous moments and preserve memories on the go. The advancement of camera technology in smartphones has greatly improved image quality and functionality, making it easier for users to take high-quality photos and videos. Social media platforms and photo-sharing apps have made it effortless to instantly share photos with friends and family, providing validation and connection. Editing apps and tools provide creative options to enhance and customize photos and video clips, adding to the enjoyment. The digital storage capacity of mobile devices, coupled with multimedia organization apps, enables users to manage and access their photos and videos easily. Ultimately, using mobile phones for capturing photos and videos and creating memories serves as a means to document personal experiences and preserve sentimental moments for future enjoyment and reflection.

Additionally, the rise of social media has revolutionized the way people connect, communicate, and share content worldwide. Online communities and social media platforms, particularly those accessible via mobile applications, have become ubiquitous tools for individuals to express themselves, connect with others, and share their experiences. These communities and platforms have facilitated the seamless sharing of various forms of media, including photos and videos, enabling users to share moments, ideas, and artistic creations with a wide audience.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 illustrates an example networked system environment comprising multiple user systems, servers, and a network, in which the techniques for generating condensed media previews described in the present disclosure may be implemented.

FIG. 2 illustrates a block diagram of an example interaction system architecture comprising client-side and server-side components that enable messaging and content creation functionality, in accordance with some examples.

FIG. 3 illustrates a schematic diagram of example data structures stored in a database, in accordance with some examples.

FIG. 4 illustrates a schematic diagram illustrating the structure and components of a message, in accordance with some examples.

FIG. 5 illustrates a system and high-level overview of a technique for generating an abbreviated version of a larger media collection, referred to as a “mashup”, using a mashup template, consistent with some examples.

FIG. 6 illustrates an example user interface of a mobile application displaying a mashup with interface elements allowing the user to share or edit the mashup, consistent with some examples.

FIG. 7 illustrates an example process flow for generating a mashup from a media collection based on a mashup template, consistent with some examples.

FIG. 8 is a diagrammatic representation of a machine in the form of a computer system within which a set of instructions may be executed to cause the machine to perform any one or more of the methodologies discussed herein, according to some examples.

FIG. 9 is a block diagram showing a software architecture within which examples may be implemented.

### DETAILED DESCRIPTION

Described herein are techniques for generating a condensed, editable preview of a digital media collection by extracting only the most compelling constituent media elements. This abbreviated version is referred to as a “mashup.” The mashup is programmatically created by selectively choosing a subset of media items from a larger “featured story” collection based on optimized selection criteria aimed at identifying the most engaging highlights. A specialized mashup template defines these optimized criteria to select the most impactful moments from the featured story. The template may consider factors such as emotional resonance, visual appeal, story cohesion, and time relevance when extracting media items from the featured story. By consolidating only the most captivating content, the mashup provides a shortened encapsulation that maintains viewer interest. Enabling further user customization and editability of the mashup enhances shareability. In the following description, numerous implementation details are set forth to provide an understanding of different examples. However, it will be evident that the techniques may be practiced using alternative configurations consistent with the principles described herein.

Many mobile applications leverage the camera(s) of a mobile computing device (e.g., a mobile phone) to allow end-users to capture and store large collections of photos and videos (or video clips). In fact, it is generally so easy to capture and share photos and video clips that the size of any one end-user's collection may become extremely large, preventing that user from easily finding and viewing photos and videos that depict his or her favorite moments. To that end, some online services and/or mobile apps may provide a “featured story” service to automatically generate what are referred to herein as featured stories. Such services, whether called Featured Stories, Moments, Memories, Highlights, or something else, enhance the user experience by providing delightful throwbacks that reignite nostalgia for those captured times, and enhance the overall user experience by providing a delightful surprise and reigniting the joy associated with those captured memories.

In the context of social media and photo sharing apps, a story is usually a short, sequence of images or videos, which may be augmented or otherwise accompanied by backgrounds, music, texts, stickers, animations, effects and emojis. Many social media and photo sharing apps provide editing tools that allow users to create their own stories from the various photos and video clips that the user captures. Using these tools, a user can select various photos and videos, editing each one individually, for example, by augmenting a photo or video with various special effects, and then save or share the resulting story. The story may automatically play, presenting in sequence each individual photo or video, when another user selects the story for viewing.

For purposes of the present disclosure, a featured story is similar to a story, but is automatically and programmatically generated by a featured story service, typically based on a story template, where the individual content items are selected for inclusion in the featured story based on some common theme. For example, a featured story may be generated to include a collection of photos and videos that were captured at a specific time—e.g., this day one year ago, this week (or, month) one year ago, five years ago, and so forth. Alternatively, a featured story may be generated to include a collection of photos and videos that were captured at or around a particular location or place. For example, a featured story may be generated to include a collection of media content items that were captured during a vacation, where the meta-data associated with each media content item is used to select the content item by time and location. By analyzing a user's location over a period of time, the featured story service may determine when the user is in a location that the user does not frequently visit, which may be a signal that the user is traveling.

Accordingly, a featured story service may automatically generate a featured story by employing various techniques to select a collection of media content items that share a common theme, a common timeframe, a common location, or some combination. One approach to generating a feature story involves analyzing the metadata associated with various media files, such as date, time, and geolocation information. The featured story service could use this data to identify a set of photos or videos that were taken around the same time or at a specific location, such as during a vacation. By considering the proximity of timestamps and geolocation data, the system can gather media content items that likely belong to the same event or timeframe.

Another approach to generating a featured story involves utilizing advanced image recognition and machine learning algorithms. For example, the featured story service can leverage deep neural networks and computer vision models to analyze the visual content of photos and videos. These algorithms can detect faces and recognize people by matching facial features against a database of facial profiles. This enables the models to identify individuals appearing in the media items. Additionally, the algorithms can identify specific landmarks, geographical features, buildings, and other elements to determine the location depicted in a photo or video. The models can be trained on large datasets to recognize common vacation spots and locations by learning the typical scenery, architecture, and visual details. Beyond visual analysis, the service can process metadata like geotags, timestamps, and user-provided captions to gather related media assets. By combining computer vision with metadata, the system can reliably associate photos and videos from the same event, trip, or time period by recognizing the people, places, and other contextual clues that connect the media items into a cohesive story.

Furthermore, the featured story service may consider user-generated data, such as tags, captions, or comments, associated with the media content items, particularly when the user has performed some editing on the media content item, and/or has previously shared a specific media content item with others. The featured story service can analyze this textual information to identify keywords or phrases related to vacations, holidays, or specific events, such as family gatherings, sporting events, dining out events, and so forth. Based on these textual cues, the system can gather a collection of media content items that are likely part of a cohesive story.

Once the relevant media content items are identified or selected, the featured story service can automatically edit and arrange them in a visually appealing, coherent sequence. The story template may specify an audio track consistent with the theme, and the programmatic editing can synchronize transitions between photos and videos with the audio beats and cues. This automated process involves creating a slideshow or timeline-style presentation that showcases the selected media items in a logical, thematic order. The featured story service may add titles, subtitles, and audiovisual transitions tailored to the tempo of the specified audio track to enhance the flow and viewing experience. In some cases, comments or other associated textual elements previously made on shared media items may also be overlaid to provide additional context. Each featured story is generated based on predefined templates that determine media selection criteria and arrangement characteristics. The resulting featured story is then presented to the user for viewing and sharing. Enabling automated synchronization of transitions to a thematic audio track, along with the potential addition of overlaid comments, enhances the cohesiveness, engagement and shareability of the generated featured story.

Featured stories, and similar services that automatically generate collections of related media content items, are useful because they surface photos and videos that users may not actively search for or otherwise revisit on their own. By intelligently curating and presenting these memories, the featured stories service brings forgotten or overlooked moments back into the spotlight, allowing users to rediscover and enjoy content they may have otherwise missed. These automatically curated and edited collections of media content items allow individuals to relive and share their past experiences effortlessly, fostering a sense of connection with their own lives and with others.

However, featured stories can often be quite lengthy, sometimes running thirty seconds or longer. This extended duration may cause users to lose interest for a variety of reasons before viewing the content in its entirety. Users may lose patience with the long runtime or get distracted and abandon playback midway. The story may start off strong but meander into less compelling content later on, failing to hold the viewer's attention span. Excessive length dilutes the most impactful moments and makes the featured story feel bloated rather than concise. As a result, users may miss the most engaging highlights contained towards the end of lengthy featured stories. Additionally, if users do not watch a featured story to completion due to its prolonged runtime, they may be less likely to share the full featured story with others.

Consistent with examples, for any automatically curated, long format collection of media items presented sequentially as a story or slideshow, a mashup may be generated from a mashup template. In this context, a mashup is a condensed or abbreviated version of the full story created by processing a template—for example, a mashup template. The mashup template specifies content selection criteria to select only the most compelling media items from the full collection for inclusion in the mashup. For video clips, the mashup service can utilize video analysis algorithms to identify the most engaging segments. For example, it may detect sections with high motion, emotional facial expressions, or pivotal moments by analyzing factors like color, objects, speech, and scene changes. Using this analysis, the most compelling portion of a longer video can be extracted—such as a short clip of a child blowing out birthday candles rather than the full multi-minute video. The shortened compelling clip is then included in the mashup. As such, the mashup provides a condensed summary showcasing the very best highlights and moments from the longer form story in a more digestible compilation.

A key advantage of a mashup, consistent with some examples, is that each mashup is generated in a way that allows end-users to edit the automatically created media item prior to sharing. This level of editability distinguishes mashups from other automated tools and services that do not enable user customization of generated content. Specifically, editing tools give users the ability to swap content items, adjust clip durations, modify selected portions of video clips, and augment photos or videos with stickers, text, overlays, special effects. In some cases, each media clip may be editable individually, for example, by allowing the user to augment a photo or video clip. In some examples, audio effects may be added. Similarly, the user may be able to add a new audio track, such as a music file, or swap an existing audio track for a new or different one. By empowering users to tweak and tailor the automatically generated mashups to their preferences before sharing, mashups provide a more personalized creation experience.

Consistent with some examples, each mashup may be presented as a single, stand-alone content item that can be immediately shared by itself. The mashup may optionally include a link or button to access the full, original featured story from which it was derived, for users who wish to view the longer version after seeing the highlights in the mashup. Alternatively, the mashup may be automatically prepended or inserted as the first clip at the beginning of the full featured story, serving as a preview that shows the highlights before presenting the remaining content. Mashups may also be generated not just for featured stories, but for other auto-generated collections like live stories or event stories. Live stories compile user-submitted content from various people at a specific event or location in real-time. Event stories similarly gather media content from multiple users who attended the same event. Mashups provide a condensed preview of the best moments from these crowd-sourced stories as well.

By automatically generating a mashup—an abbreviated version of a story—the mashup will increase user engagement and encourage sharing, because the mashup condenses the content into a more digestible and captivating format. For example, by using optimized content selection criteria, the mashup will include only the best and most impactful moments, highlights, or key elements of the story, the shorter version grabs the viewer's attention, maintaining their interest and prompting them to share the condensed experience with others, enticing them to discover the full story. Other advantages and aspects are presented in connection with the description of the various figures that follows.

### Networked Computing Environment

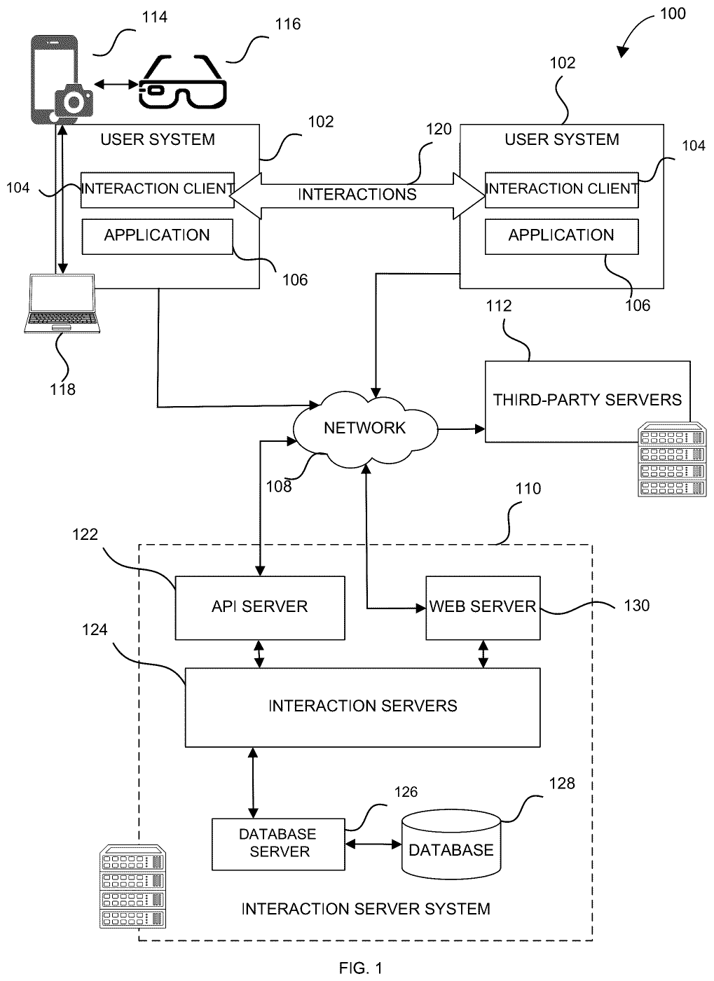

FIG. 1 illustrates an example interaction system 100 that enables users to share and interact with content such as messages, stories, and mashups over a network 108. The system includes multiple user systems 102, each hosting an interaction client application 104 that communicates over the network 108 with other interaction clients 104, an interaction server system 110, and third-party servers 112. Each user system 102 may comprise various devices that exchange data and messages, such as a mobile device 114, head-wearable apparatus 116, and computer client device 118. The interaction client 104 on each user system 102 communicates with other interaction clients 104 and the interaction server system 110 over the network 108. This communication involves exchanging functions (e.g., commands) and payload data (e.g., text, audio, video).

The interaction server system 110 provides back-end functionality over the network 108 to support the interaction clients 104. The division of operations between the interaction clients 104 and server system 110 may be a design choice. Initial deployment may be on the server side before migrating functionality to the interaction clients 104 as their capabilities grow. The interaction server system 110 performs various services for the interaction clients 104, including transmitting, receiving, and processing data like messages, device info, locations, media, content conditions, relationships, and events. The interaction clients 104 invoke these services through their user interfaces. The server system 110 includes an API server 122, interaction servers 124, a database server 126, and a web server 130.

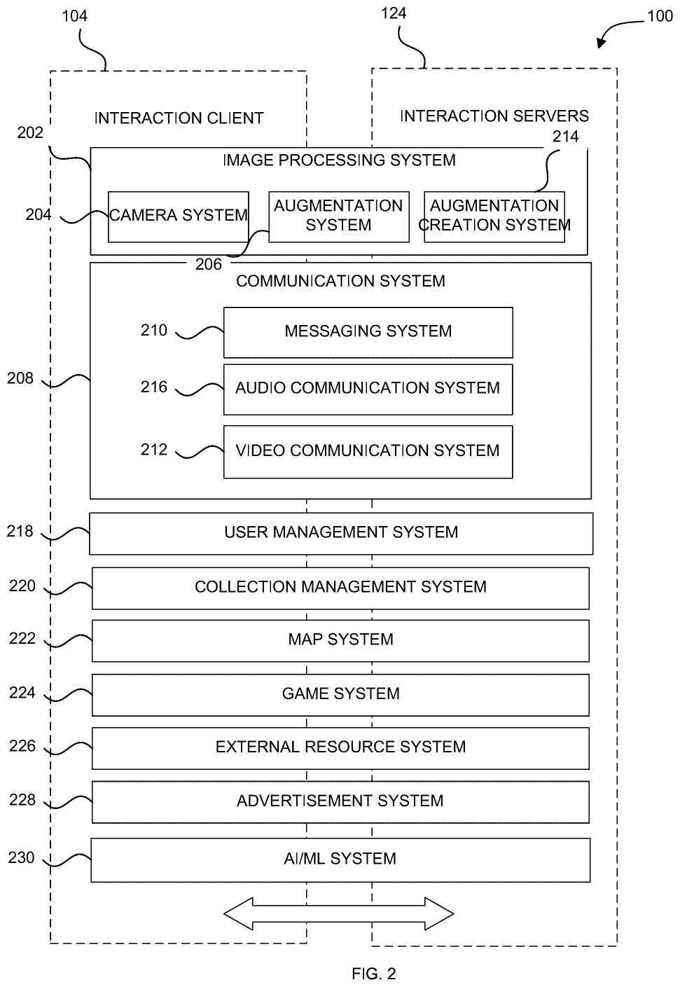

The API server 122 interfaces between the interaction clients 104 and the interaction servers 124, exposing functions like registration, messaging, media sharing, content curation, social graphs, and application events. The interaction servers 124 connect to the database server 126 to access a database 128 that stores interaction data. The web server 130 handles HTTP requests. The interaction servers 124 host various subsystems shown in FIG. 2.

### System Architecture

FIG. 2 depicts a block diagram of an example system architecture comprising client-side and server-side components that enable messaging that enable messaging and content creation functionality, in accordance with some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 100 may employ a monolithic architecture, a service-oriented architecture (SOA), a function-as-a-service (FaaS) architecture, or a modular architecture. Example subsystems are discussed below.

An image processing system 202 provides various functions that enable a user to capture and augment (e.g., annotate or otherwise modify or edit) media content associated with a message or story.

A camera system 204 includes control software (e.g., in a camera application) that interacts with and controls hardware camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an augmented reality special effect) to the interaction client 104 for the augmentation of real-time images received via the camera system 204 or stored images retrieved from memory of a user system 102. These augmentations are selected by the augmentation system 206 and presented to a user of an interaction client 104, based on a number of inputs and data, such as for example:
Geolocation of the user system 102; and.
Entity relationship information of the user of the user system 102.

An augmentation may include audio and visual content and visual effects. Examples of audio and visual content include pictures, texts, logos, animations, and sound effects. Visual effects may include augmented reality elements that track and overlay the face or body of a user depicted in an image or video. For example, augmented reality masks, filters, or effects can be applied to a user's face in real-time by detecting facial features and mapping the visuals onto the face as it moves. Similarly, virtual outfits or accessories can be overlaid onto a user's body by tracking their silhouette and proportions. Color overlaying is another example of a visual effect that can be applied. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

A media overlay may include text, images, or graphical elements that can be overlaid on top of a photograph, video stream, or live camera feed captured by the user system 102. Examples of media overlays include location-based filters such as “Venice Beach” or “Paris”; names of live events or destinations like “Coachella Music Festival”; merchant or business information overlays such as “Beach Coffee House”; and interactive augmented reality effects. The image processing system 202 can identify relevant media overlays based on the geolocation of the user system 102 provided by GPS or other location sensors. For instance, when a user is physically present at the location of a merchant like a coffee shop, the corresponding merchant overlay can be presented to the user. The media overlay may include the name, logo, address, ratings, photos, or other indicia associated with a business to overlay on images. Media overlays can be stored in a database 128 and accessed via a database server 126. The image processing system 202 can match the appropriate media overlay to the user's location and current camera viewpoint. Media overlays provide contextual, interactive augmentations to photos and videos based on the user's real-world physical environment.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 308, entity graphs 310 and profile data 302) regarding users and relationships between users of the interaction system 100.

A collection management system 220 is operationally responsible for managing sets or collections of media (e.g., collections of text, image, video, and audio data). A collection of content (e.g., messages, including images, video, text, and audio) may be organized into an “event gallery” or an “event story” or a “story.” Such a collection may be made available for a specified time period, such as the duration of an event to which the content relates. For example, content relating to a music concert may be made available as a “story” for the duration of that music concert. The collection management system 220 may also be responsible for publishing an icon that provides notification of a particular collection to the user interface of the interaction client 104. The collection management system 220 includes a curation function that allows a collection manager, or user, to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content curation and selection rules to select and curate a content collection (e.g., a story) automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

An artificial intelligence and machine learning system 230 provides a variety of services to different subsystems within the interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the augmentation system 206 to generate augmented content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the interaction server system 110. The artificial intelligence and machine learning system 230 may also work with the audio communication system 216 to provide speech recognition and natural language processing capabilities, allowing users to interact with the interaction system 100 using voice commands.

### Data Architecture

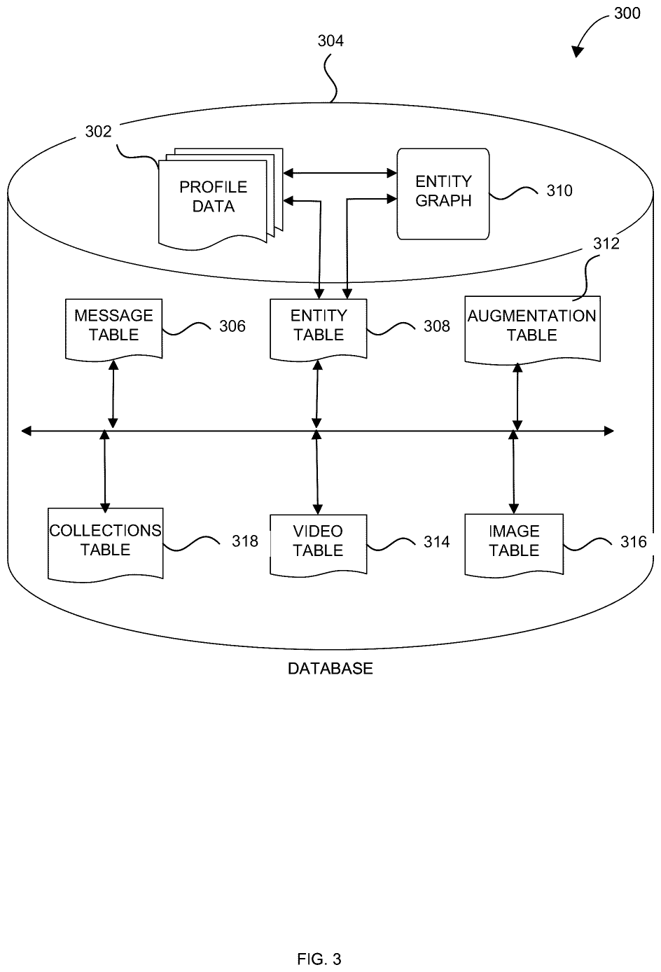

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database).

The database 304 includes message data stored within a message table 306. This message data includes, for any particular message, at least message sender data, message recipient (or receiver) data, and a payload. Further details regarding information that may be included in a message, and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 308. Such privacy settings may be applied to all types of relationships within the context of the interaction system 100, or may selectively be applied to certain types of relationships.

The profile data 302 stores multiple types of profile data about a particular entity. The profile data 302 may be selectively used and presented to other users of the interaction system 100 based on privacy settings specified by a particular entity. Where the entity is an individual, the profile data 302 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content items (e.g., corresponding to applying “Lenses®” or augmented reality experiences). An augmented reality content item may be a real-time special effect and sound that may be added to an image or a video.

A collections table 318 stores data regarding collections of messages and associated image, video, or audio data, which are compiled into a collection (e.g., a story or a gallery). The creation of a particular collection may be initiated by a particular user (e.g., each user for which a record is maintained in the entity table 308). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 may associate various augmentations from the augmentation table 312 with various images and videos stored in the image table 316 and the video table 314.

In some examples, the databases 304 also includes tables for storing data relating to mashups—abbreviated or shorter versions of a featured story. Mashups are described in greater detail below.

### Data Communications Architecture

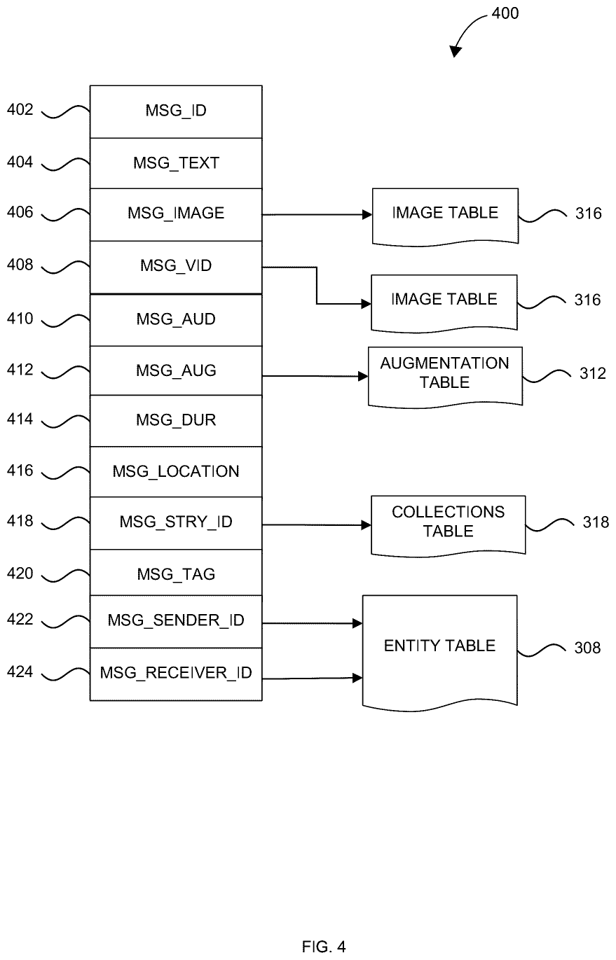

FIG. 4 is a schematic diagram illustrating a structure of a message 400, according to some examples, generated by an interaction client 104 for communication to a further interaction client 104 via the interaction servers 124. The content of a particular message 400 is used to populate the message table 306 stored within the database 304, accessible by the interaction servers 124. Similarly, the content of a message 400 is stored in memory as “in-transit” or “in-flight” data of the user system 102 or the interaction servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 316.
Message video payload 408: video data, captured by a camera component or retrieved from a memory component of the user system 102, and that is included in the message 400. Video data for a sent or received message 400 may be stored in the image table 316.
Message audio payload 410: audio data, captured by a microphone or retrieved from a memory component of the user system 102, and that is included in the message 400.
Message augmentation data 412: augmentation data (e.g., filters, stickers, or other annotations or enhancements) that represents augmentations to be applied to message image payload 406, message video payload 408, or message audio payload 410 of the message 400. Augmentation data for a sent or received message 400 may be stored in the augmentation table 312.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message story identifier 418: identifier values identifying one or more content collections (e.g., “stories” identified in the collections table 318) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 316. Similarly, values within the message video payload 408 may point to data stored within an image table 316, values stored within the message augmentation data 412 may point to data stored in an augmentation table 312, values stored within the message story identifier 418 may point to data stored in a collections table 318, and values stored within the message sender identifier 422 and the message receiver identifier 424 may point to user records stored within an entity table 308.

### Mashups

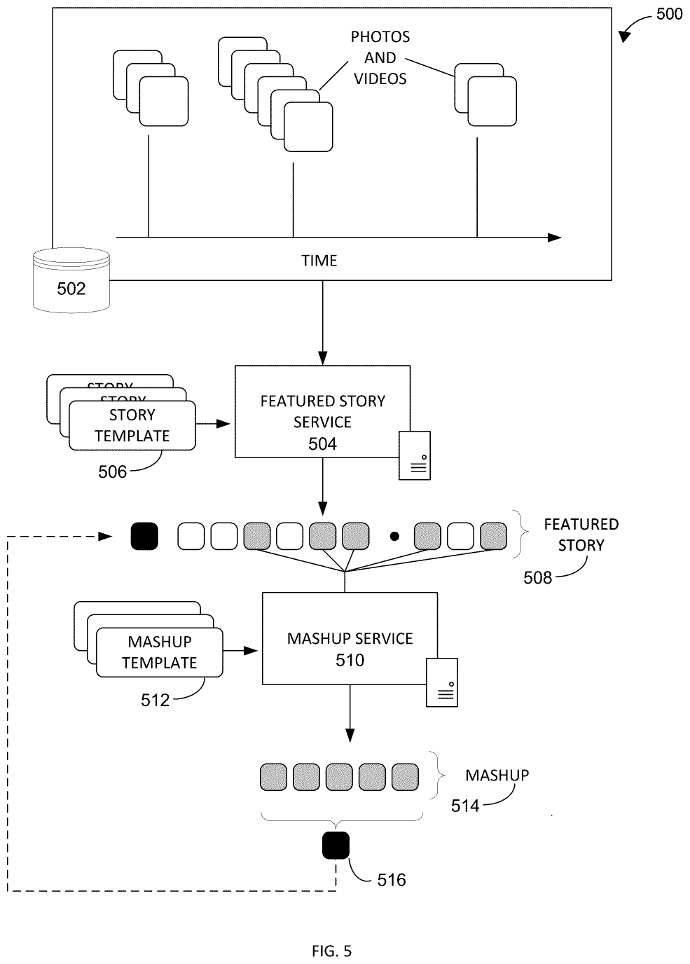

FIG. 5 is a diagram illustrating a high-level view of a system 500 and technique by which a mashup 514 is generated, using a mashup template 512, consistent with some examples. As shown in FIG. 5, a database 502 is storing a collection of media content items (e.g., images or photos, and videos). The database 502 may reside on a server, or the database may reside on the client device of the user to whom the mashup is to be presented. In some examples, as a user obtains media content items on his or her user system 102 or client device (e.g., a mobile computing device or mobile phone), the user system 102 may communicate a copy of each media content item to a server, where the media content items are stored. Accordingly, in some examples, the relevant media content items may be synchronized between a client and server. In this example, the photos and videos are shown to be stored, indexed by the data/time the content item was created. Although not shown, the media content items are associated with a variety of meta-data, including any, or any combinations, of the following:
Date and time: The exact date and time the photo was taken.
Location: The GPS coordinates or geotag of where the photo was captured.
Camera information: Details about the mobile device's camera, such as make, model, and settings used (e.g., aperture, shutter speed).
File format: The format of the image file, such as JPEG, PNG, or HEIC.
File size: The size of the image file in kilobytes (KB) or megabytes (MB).
Resolution: The dimensions of the image in pixels (width x height).
Orientation: The orientation of the photo (landscape or portrait).
Exposure information: Metadata related to exposure settings, such as ISO, exposure compensation, and focal length.
Software information: Details about the app or software used to capture or edit the photo.
User-defined tags or keywords: Custom tags or keywords added by the user to categorize or describe the photo.
Alt text: A brief text description of the image for accessibility purposes.
Image title or caption: A title or caption given to the photo by the user.
Copyright information: Information about the copyright holder or licensing terms for the image.
File modifications: Metadata indicating any modifications made to the original image file, such as cropping, filters, or edits.

The featured story service 504 will periodically process a story template 502 to generate a featured story for a user, along with a corresponding mashup 514. The story template 502 may express certain requirements that must be met in order to generate the story, such as a minimum threshold of content. For example, the template may specify that at least ten photos and three video clips totaling sixty seconds in length must exist in order to produce the featured story. The featured story service 504 operates on a schedule to periodically determine if the template criteria are satisfied. For instance, if a template is designed to generate a story based on a specific time period, the service will evaluate whether enough photos and videos from that timeframe exist. The template may also express selection criteria like location, depicted persons, or events that are used to identify relevant media items. By processing these template rules, the service can determine if sufficient content meeting the criteria is available to generate the complete featured story. If so, the service will compile the story and corresponding mashup for presentation to the user.

As illustrated in FIG. 5, the featured story service 504 will process a story template 506 to generate a featured story. Although not expressly shown in FIG. 5, a story template 506 will generally specify content selection criteria for selecting the media content items to include in the featured story. The content selection criteria for a featured story may be similar in nature to the content selection criteria used for selecting content items to be included in a mashup of the featured story. These characteristics for content selection are described below.

Once the featured story 508 has been automatically generated, a mashup template 512 that corresponds with the featured story is selected and processed. Here, each type of featured story is associated with a mashup template. Accordingly, after a featured story 508 has been derived by the featured story service 504, the mashup service 510 will select the appropriate mashup template 512, for example, by preforming a lookup operation to identify the mashup template 512 that has been designated for a particular featured story type.

The mashup service 510 will process the mashup template 512, in part, by using content selection criteria included or specified as part of the mashup template 512 to select specific media content items included in the featured story 508, for including in the mashup 516. As shown in FIG. 5, the media content items that are selected for inclusion in a mashup are a subset of the media content items included in the featured story. One objective of the content selection criteria for creating the mashup is to select the content items that represent the highlights, or the most compelling and interesting and engaging moments. Of course, each mashup template 506 may have different selection criteria, based on any of a variety of factors. Here are some of the various content selection criteria that may be used to select content items to include in the mashup:
Engagement rate: Identifying media content items that received a high engagement rate in terms of likes, comments, and shares compared to the total number of views or followers.
Virality: Considering media content that went viral or gained significant traction beyond the users immediate network or friend group, indicating its widespread appeal.
Quality and aesthetics: Selecting media content that exhibits high-quality visuals, composition, artistic appeal, or uniqueness in capturing moments.
Storytelling: Choosing media content items that effectively tell a compelling or interesting story through visuals, captions, or accompanying text.
Time relevance: Prioritizing media content items that are timely and relevant to current events, trends, or topics of interest.
Personal significance: Considering media content that holds personal significance to the user, such as capturing important milestones, memorable experiences, or sentimental moments.
Diversity: Ensuring a diverse range of content types, such as photos, videos, Boomerangs, or Live Stories, to provide a well-rounded representation of the user's experiences.
Variety of subjects: Including media content that covers a wide range of subjects or themes, reflecting the user's diverse interests and activities.
User interactions: Taking into account media content items that sparked meaningful conversations, discussions, or interactions among users.
User preferences: Utilizing user preferences and settings, such as content filters, privacy settings, or customized sorting options, to personalize the selection of the best content media items according to individual preferences.
Diversity in time: Where the candidate content items represent a wide range of time, selecting strategically to ensure that some content items from each interval of time will be included in the mashup. This may be dependent upon the number of media content items to be included in the mashup, as specified by the mashup template.

In some examples, once the media content items have been selected for inclusion in the mashup, additional analysis may be done to arrange the media content items optimally, based on the nature of the featured story and the mashup. For example, various criteria may be considered in specifying a template directive for arranging the selected media content items for the mashup:
Chronological order: Arranging the media content items based on the time they were captured or uploaded, creating a coherent timeline that follows the sequence of events or moments.
Visual continuity: Organizing the photos and video clips in a visually pleasing and seamless manner, considering factors like composition, color schemes, and transitions between media items.
Key moments or highlights: Identifying and featuring the most significant or memorable moments from the collection to create a compelling narrative that captures the essence of the story.
Emotional impact: Arranging the media content items to evoke emotional responses or create a specific mood, considering factors like joy, excitement, nostalgia, or inspiration.
Story flow and coherence: Ensuring a logical and coherent flow of the story by arranging the media content items in a way that connects and builds upon each other, maintaining a cohesive narrative arc.

In some examples, the mashup template may specify an audio file, for example, including music and/or sound effects. Accordingly, at least with some examples, the arrangement and presentation of photos and video clips within the mashup may be set so that visual transitions are synchronized with the audio of the selected audio file. In some examples, to create a compelling mashup that has visual transitions synchronized to music, a software process leverages algorithms and techniques for automating the performance of synchronized audio-visual editing, as follows:
Audio analysis: The software would analyze the audio track specified by the mashup template, detecting key beats, rhythm changes, and other musical cues. This analysis could involve techniques like audio waveform analysis, tempo detection, or beat tracking algorithms. This may also be done manually.
Media analysis: The software would analyze the photos and video clips to extract relevant information such as duration, visual content, and metadata. This analysis might include image recognition algorithms to identify key moments or visual features.
Synchronization algorithm: Using the audio analysis results, the software would determine the optimal timing and placement of each media content item. It would calculate when to start and end each item based on the identified beats or cues in the audio track.
Transition algorithm: The software would employ transition algorithms to create seamless transitions between media content items. These algorithms might include predefined transition effects or more advanced techniques like morphing, crossfading, or scene matching to ensure smooth visual transitions.
Editing and rendering: Once the synchronization and transition algorithms have been applied, the software would generate the final edited story, integrating the media content items with the synchronized audio track. This process may involve video rendering, encoding, and exporting the finished product in the desired format.

As shown in FIG. 5, the mashup service 510 generates the mashup 514 by combining the selected media items into a single condensed video clip or file 516 for presentation. However, the individual components used to create the mashup 514 can also be maintained as separate editable objects. This allows the user to modify the automatically generated mashup 514 prior to sharing or adding it to the featured story. For example, the user may be able to swap or trim individual clips, add filters and effects, or rearrange the structure of the mashup. Maintaining the mashup 514 as both a single rendered video output 516 and a collection of separate editable objects provides flexibility. The user can watch and share the mashup 516 video immediately. But the user can also customize the mashup 514 further by editing the individual pieces, before producing an updated rendered version 516. Once finalized, the mashup 516 can be inserted as a preview at the start of the full featured story. Enabling this editing allows the user more control over the automated mashup 514 creation process.

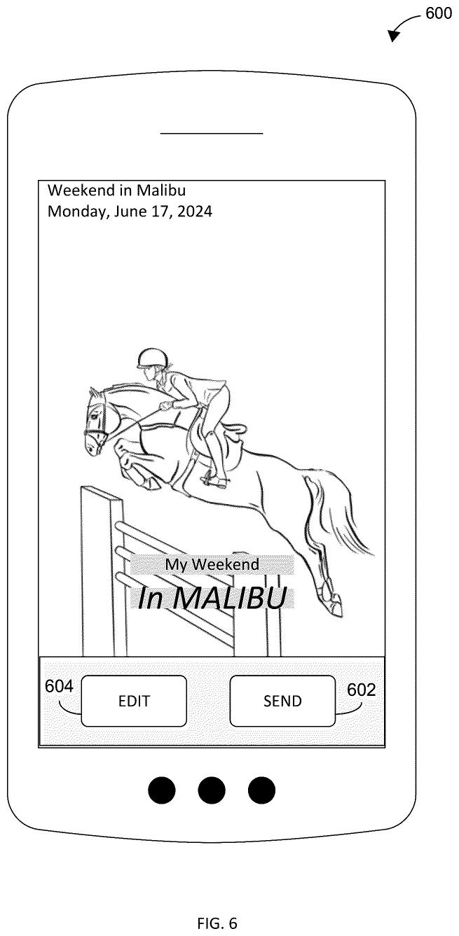

FIG. 6 illustrates an example interface 600 of a mobile application displaying a mashup. The image shown is just the first frame or intro section of the full mashup video. The mashup can be shared as a separate condensed clip or file via the “Send” button 602. Alternatively, it can be added to the front of the original full-length story it was derived from. The mashup may also include a link or button to access the related full story for viewing. Selecting the “Edit” button 604 allows the user to launch an editing interface to further customize the generated mashup, such as by modifying individual clips, adding filters and effects, rearranging components, or tweaking audio. The “Send” button 602 may provide options to share the mashup, and optionally the full story, to various destinations—such as posting to a social media feed, sending to individual contacts or groups, or exporting to external apps and services. Enabling easy sharing and editing helps promote user engagement with the mashup and story.

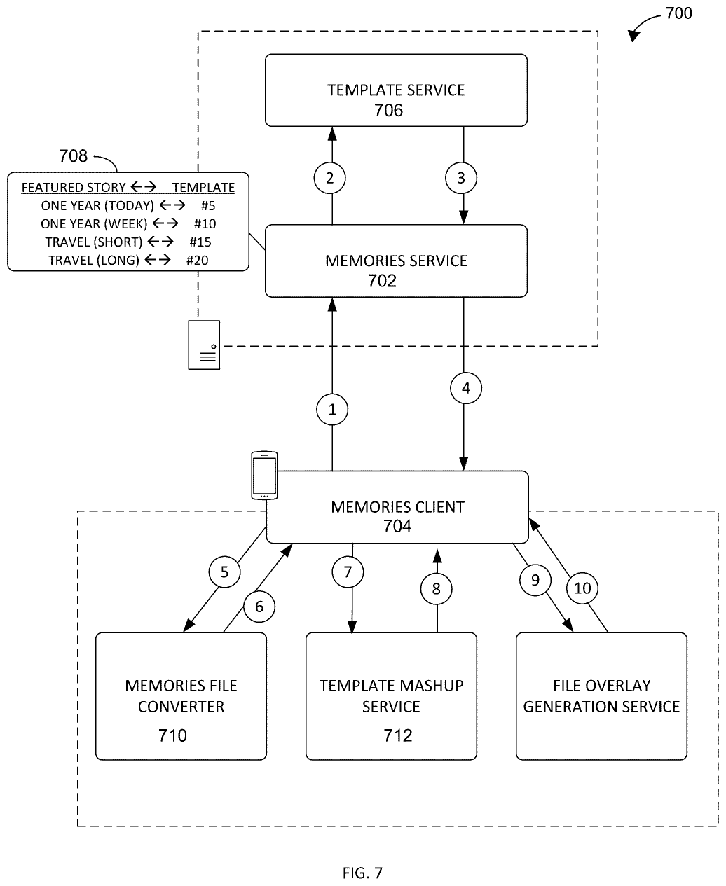

FIG. 7 illustrates an example process flow for generating a mashup from a media collection based on a mashup template, consistent with some examples. The subject matter depicted in FIG. 7 represents merely one example implementation, and a wide variety of alternative implementations may be employed while remaining generally consistent with and within the scope of the subject matter as claimed. Consistent with some examples, and as shown in FIG. 7, the mashup creation process utilizes both a memories service 702, which resides on the cloud/server side, and a memories client 704, which executes locally on the user's device. As shown in FIG. 7, it is assumed that a featured story has already been generated prior to the depicted steps. The memories service 702 and memories client 704 then operate in conjunction to produce the corresponding mashup for that existing featured story. The memories service 702 handles backend operations like obtaining the appropriate template while the memories client 704 performs client-side tasks like converting files and generating the mashup using the mashup template. The two components work together, leveraging both cloud-based and local device resources, to automate mashup creation for a given featured story. As described below, before a mashup can be generated, there are several administrative or setup tasks that must be completed.

Consistent with some examples, the process of creating and generating mashups from templates involves three main stages. First, a content designer uploads an existing media item to a mashup template service 706 and edits it to create a reusable mashup template, specifying an identifier (e.g., a mashup ID) and associated story type. For example, each mashup template may be mapped to a specific type or story, or story template, by corresponding identifiers. For instance, as shown with reference 708, the memories service 702 may access a table or other data structure, which maps each type of featured story to a particular mashup, by mashup identifier. Next, when a featured story is generated, the memories client 704 residing and executing on the client device, will request from the memories service 702 a mashup template, corresponding with a featured story. Finally, the memories client 704 will convert the story's media items into a compatible format, use the mashup template to produce the mashup with those items, and persist the mashup or add it to the story. The individual processing steps—identified by numbers enclosed with a circle in FIG. 7—are described below.

In the processing step labeled as (1), the memories client 704 residing and executing on the user's client device, generates and transmits to the memories service 702 a request for any relevant featured stories, for example, for which a mashup is to be generated. The memories service 702 receives and processes the request for the user of the mobile app by fetching the mashup template having the template identifier that corresponds with each featured story for which a mashup is to be generated. This is done using the mapping service 708 of the memories service 702, which maps each featured story type to a corresponding mashup identifier. For example, in FIG. 7, a featured story may be generated to present to the user relevant content that was generated exactly one year ago, from the current day—shown in FIG. 7 as “one year (today).” As shown in FIG. 7, this featured story maps to the mashup template identified as “#5.” Accordingly, at the processing step labeled as (2), the template service 702 will invoke a request to the template service 706, requesting the mashup template for each mashup that is to be generated for a featured story. At the processing step labeled as (3), the template service 706 replies to the request by communicating to the memories service 702 the requested mashup templates. At the step labeled as (4), the memories service 702 communicates over a network to the memories client 704 the relevant featured stories and their corresponding mashup templates, which will be used by the memories client to generate the mashups for each featured story.

Note, in some examples, the relevant media for the featured story may be resident on the client. However, in some instances, some or all of the relevant media content items for a featured story may be resident on a server. Accordingly, at least with some examples, some or all media content items for a featured story may be communicated from the memories service 702 to the memory client 704. For example, in some instances, the memories client may first analyze a local database to ensure each media content item referenced in a story is stored locally, and then for those content items that may not be local, the memories client 704 may request that the media content items be communicated from a server-side storage location to the client.

Next, the memories client will take the necessary processing steps to generate the mashup for each featured story. At the processing step labeled as (5), each media content item (e.g., each file, representing a media content item) included in a featured story is processed by the memories file converter to generate a media content item that is in a format suitable for the mashup. In some instances, this means removing certain edits to a content item. At the step labeled as (6), the converted media content items are communicated to the memories client for further processing.

At the processing step labeled as (7), the memories client 704 sends the mashup template and converted media content items (files) to the template mashup service 712, where the mashup template is processed to create a single, consolidated media content item, including all the edits specified by the mashup template. At the processing step labeled as (8), the consolidated media content item is communicated to the memories client 704.

At the processing step labeled as (9), the file overlay generation service 714 receives from the memories client 704 the consolidated file representing the mashup. The file overlay generation service 714 then adds the mashup to the featured story, for example, by prepending the file representing the mashup to the file representing the featured story. Finally, at the processing step labeled as (10), the memories client 704 receives the final featured story with the prepended mashup, and the featured story with mashup are made available, for presentation to the user.

Although not shown in FIG. 7, in various examples, the individual media content items included in the mashup may be stored separately, and made available to the user along with other media content items, so that the user can edit the mashup before it is shared with others, or prepended to the featured story.

### Machine Architecture

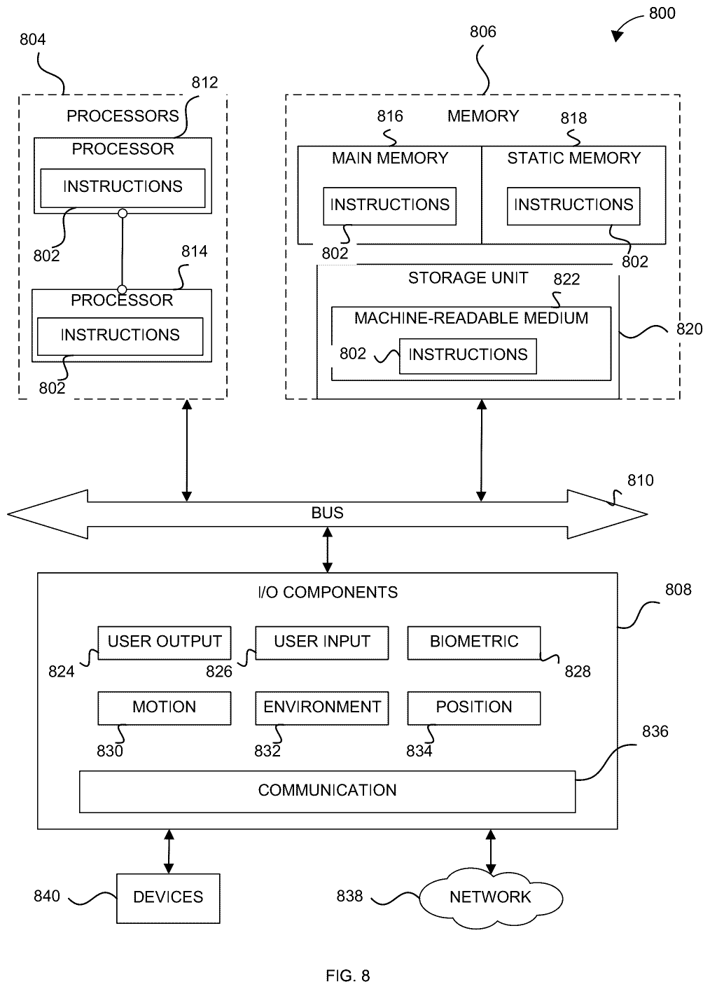

FIG. 8 is a diagrammatic representation of the machine 800 within which instructions 802 (e.g., software, a program, an application, an applet, an app, or other executable code) for causing the machine 800 to perform any one or more of the methodologies discussed herein may be executed. For example, the instructions 802 may cause the machine 800 to execute any one or more of the methods described herein. The instructions 802 transform the general, non-programmed machine 800 into a particular machine 800 programmed to carry out the described and illustrated functions in the manner described. The machine 800 may operate as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 802, sequentially or otherwise, that specify actions to be taken by the machine 800. Further, while a single machine 800 is illustrated, the term “machine” shall also be taken to include a collection of machines that individually or jointly execute the instructions 802 to perform any one or more of the methodologies discussed herein. The machine 800, for example, may comprise the user system 102 or any one of multiple server devices forming part of the interaction server system 110. In some examples, the machine 800 may also comprise both client and server systems, with certain operations of a particular method or algorithm being performed on the server-side and with certain operations of the particular method or algorithm being performed on the client-side.

The machine 800 may include processors 804, memory 806, and input/output I/O components 808, which may be configured to communicate with each other via a bus 810. In an example, the processors 804 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 812 and a processor 814 that execute the instructions 802. The term “processor” is intended to include multi-core processors that may comprise two or more independent processors (sometimes referred to as “cores”) that may execute instructions contemporaneously. Although FIG. 6 shows multiple processors 804, the machine 800 may include a single processor with a single-core, a single processor with multiple cores (e.g., a multi-core processor), multiple processors with a single core, multiple processors with multiples cores, or any combination thereof.

The memory 806 includes a main memory 816, a static memory 818, and a storage unit 820, both accessible to the processors 804 via the bus 810. The main memory 806, the static memory 818, and storage unit 820 store the instructions 802 embodying any one or more of the methodologies or functions described herein. The instructions 802 may also reside, completely or partially, within the main memory 816, within the static memory 818, within machine-readable medium 822 within the storage unit 820, within at least one of the processors 804 (e.g., within the processor's cache memory), or any suitable combination thereof, during execution thereof by the machine 800.

The I/O components 808 may include a wide variety of components to receive input, provide output, produce output, transmit information, exchange information, capture measurements, and so on. The specific I/O components 808 that are included in a particular machine will depend on the type of machine. For example, portable machines such as mobile phones may include a touch input device or other such input mechanisms, while a headless server machine will likely not include such a touch input device. It will be appreciated that the I/O components 808 may include many other components that are not shown in FIG. 6. In various examples, the I/O components 808 may include user output components 824 and user input components 826. The user output components 824 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 826 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 808 may include biometric components 828, motion components 830, environmental components 832, or position components 834, among a wide array of other components. For example, the biometric components 628 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

### Software Architecture

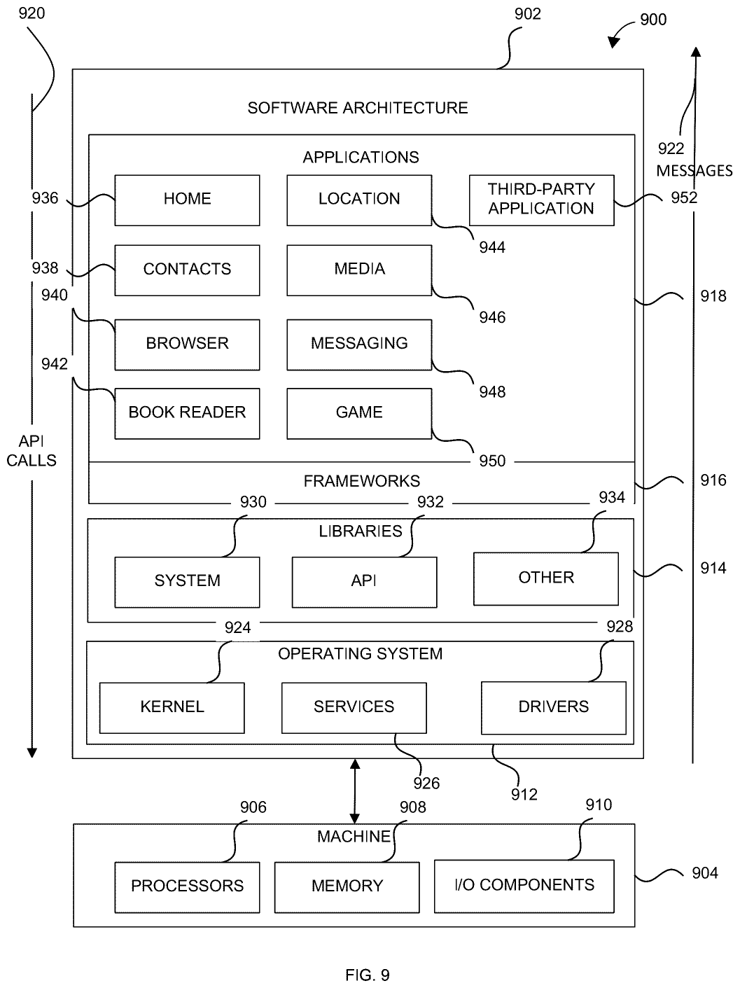

FIG. 9 is a block diagram 900 illustrating a software architecture 902, which can be installed on any one or more of the devices described herein. The software architecture 902 is supported by hardware such as a machine 904 that includes processors 906, memory 908, and I/O components 910. In this example, the software architecture 902 can be conceptualized as a stack of layers, where each layer provides a particular functionality. The software architecture 902 includes layers such as an operating system 912, libraries 914, frameworks 916, and applications 918. Operationally, the applications 918 invoke API calls 920 through the software stack and receive messages 922 in response to the API calls 920.

The operating system 912 manages hardware resources and provides common services. The operating system 912 includes, for example, a kernel 924, services 926, and drivers 928. The kernel 924 acts as an abstraction layer between the hardware and the other software layers. For example, the kernel 924 provides memory management, processor management (e.g., scheduling), component management, networking, and security settings, among other functionalities. The services 926 can provide other common services for the other software layers. The drivers 928 are responsible for controlling or interfacing with the underlying hardware. For instance, the drivers 728 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 914 provide a common low-level infrastructure used by the applications 918. The libraries 914 can include system libraries 930 (e.g., C standard library) that provide functions such as memory allocation functions, string manipulation functions, mathematic functions, and the like. In addition, the libraries 914 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 914 can also include a wide variety of other libraries 934 to provide many other APIs to the applications 918.

The frameworks 916 provide a common high-level infrastructure that is used by the applications 918. For example, the frameworks 916 provide various graphical user interface (GUI) functions, high-level resource management, and high-level location services. The frameworks 916 can provide a broad spectrum of other APIs that can be used by the applications 918, some of which may be specific to a particular operating system or platform.

In an example, the applications 918 may include a home application 936, a contacts application 938, a browser application 940, a book reader application 942, a location application 944, a media application 946, a messaging application 948, a game application 950, and a broad assortment of other applications such as a third-party application 952. The applications 918 are programs that execute functions defined in the programs. Various programming languages can be employed to create one or more of the applications 918, structured in a variety of manners, such as object-oriented programming languages (e.g., Objective-C, Java, or C++) or procedural programming languages (e.g., C or assembly language). In a specific example, the third-party application 952 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 952 can invoke the API calls 920 provided by the operating system 912 to facilitate functionalities described herein.

### EXAMPLES

Example 1 is a system comprising: at least one processor; at least one memory storage device storing instructions thereon that, when executed by the at least one processor, cause the system to perform operations comprising: receiving a first media content item comprising a plurality of media content items for sequential playback; receiving a template corresponding with the first media content item, the template specifying at least i) a number of media content items to be selected from the plurality of media content items, and ii) content selection criteria for selecting the number of media content items from the plurality of media content items; processing the template by: selecting the number of media content items from the plurality of media content items in accordance with the content selection criteria; and generating a second media content item from the number of media content items, the second media content item being an abbreviated version of the first media content item; and presenting the second media content item via a user interface.

In Example 2, the subject matter of Example 1 includes, wherein the content selection criteria comprises: selecting media content items based on a metric indicating an engagement level associated with each media content item; selecting media content items based on a measure of virality associated with each media content item; selecting media content items based on user interactions associated with each media content item; or, a combination thereof.

In Example 3, the subject matter of Examples 1-2 includes, wherein the content selection criteria comprises: selecting media content items to provide diversity in content types; selecting media content items to provide variety in subject matter depicted; selecting media content items based on user preferences; or a combination thereof.

In Example 4, the subject matter of Examples 1-3 includes, wherein the operations further comprise: receiving a selection to modify the second media content item; in response to receiving the selection, providing an interface for modifying the second media content item; receiving one or more modifications to the second media content item via the interface; generating a modified second media content item based on the one or more modifications; and presenting the modified second media content item via the user interface.

In Example 5, the subject matter of Examples 1-4 includes, wherein selecting the number of media content items comprises: inputting a video content item selected based on the content selection criteria into a machine learning model; analyzing, by the machine learning model, the video content item to identify a segment of the video content item representing a highlight portion; and extracting the identified highlight portion of the video content item as one of the number of media content items for inclusion in the second media content item.

In Example 6, the subject matter of Example 5 includes, wherein the machine learning model is trained to identify the highlight portion of a video content item by at least one of: analyzing user engagement metrics associated with a plurality of video content items to determine segments with high engagement as highlights for training data; receiving input identifying highlight segments in a plurality of video content items to generate training data; and analyzing audiovisual features such as motion, speech, scene changes, facial expressions, or lighting in a plurality of video content items to determine highlight segments for training data.

In Example 7, the subject matter of Examples 1-6 includes, wherein generating the second media content item comprises: analyzing, by the processor, an audio track specified by the template to detect audio cues within the audio track; determining time locations of the detected audio cues within the audio track; analyzing each of the selected number of media content items to determine appropriate start and end times for presentation based on the time locations of the detected audio cues; arranging the selected number of media content items according to the determined start and end times for each media content item to synchronize transitions between the selected number of media content items with the detected audio cues in the specified audio track; and combining the arranged media content items with the specified audio track to generate the second media content item having synchronized transitions.

In Example 8, the subject matter of Examples 1-7 includes, wherein the plurality of media content items were selected for the first media content item by: receiving a first template specifying criteria for selecting the plurality of media content items; analyzing a set of available media content items to identify a subset meeting the criteria of the first template; and selecting the identified subset as the plurality of media content items that were included in the first media content item.

Example 9 is a method comprising: receiving, by a processor, a first media content item comprising a plurality of media content items for sequential playback; receiving, by the processor, a template corresponding with the first media content item, the template specifying at least i) a number of media content items to be selected from the plurality of media content items, and ii) content selection criteria for selecting the number of media content items from the plurality of media content items; processing the template by: selecting the number of media content items from the plurality of media content items in accordance with the content selection criteria; and generating a second media content item from the number of media content items, the second media content item being an abbreviated version of the first media content item; and presenting the second media content item via a user interface.

In Example 10, the subject matter of Example 9 includes, wherein the content selection criteria comprises: selecting media content items based on a metric indicating an engagement level associated with each media content item; selecting media content items based on a measure of virality associated with each media content item; selecting media content items based on user interactions associated with each media content item; or, a combination thereof.

In Example 11, the subject matter of Examples 9-10 includes, wherein the content selection criteria comprises: selecting media content items to provide diversity in content types; selecting media content items to provide variety in subject matter depicted; selecting media content items based on user preferences; or a combination thereof.

In Example 12, the subject matter of Examples 9-11 includes, receiving a selection to modify the second media content item; in response to receiving the selection, providing an interface for modifying the second media content item; receiving one or more modifications to the second media content item via the interface; generating a modified second media content item based on the one or more modifications; and presenting the modified second media content item via the user interface.

In Example 13, the subject matter of Examples 9-12 includes, wherein selecting the number of media content items comprises: inputting a video content item selected based on the content selection criteria into a machine learning model; analyzing, by the machine learning model, the video content item to identify a segment of the video content item representing a highlight portion; and extracting the identified highlight portion of the video content item as one of the number of media content items for inclusion in the second media content item.

In Example 14, the subject matter of Example 13 includes, wherein the machine learning model is trained to identify the highlight portion of a video content item by at least one of: analyzing user engagement metrics associated with a plurality of video content items to determine segments with high engagement as highlights for training data; receiving input identifying highlight segments in a plurality of video content items to generate training data; and analyzing audiovisual features such as motion, speech, scene changes, facial expressions, or lighting in a plurality of video content items to determine highlight segments for training data.

In Example 15, the subject matter of Examples 9-14 includes, wherein generating the second media content item comprises: analyzing, by the processor, an audio track specified by the template to detect audio cues within the audio track; determining time locations of the detected audio cues within the audio track; analyzing each of the selected number of media content items to determine appropriate start and end times for presentation based on the time locations of the detected audio cues; arranging the selected number of media content items according to the determined start and end times for each media content item to synchronize transitions between the selected number of media content items with the detected audio cues in the specified audio track; and combining the arranged media content items with the specified audio track to generate the second media content item having synchronized transitions.

In Example 16, the subject matter of Examples 9-15 includes, wherein the plurality of media content items were selected for the first media content item by: receiving a first template specifying criteria for selecting the plurality of media content items; analyzing a set of available media content items to identify a subset meeting the criteria of the first template; and selecting the identified subset as the plurality of media content items that were included in the first media content item.

Example 17 is a system comprising: means for receiving a first media content item comprising a plurality of media content items for sequential playback; means for receiving a template corresponding with the first media content item, the template specifying at least i) a number of media content items to be selected from the plurality of media content items, and ii) content selection criteria for selecting the number of media content items from the plurality of media content items; means for processing the template by: selecting the number of media content items from the plurality of media content items in accordance with the content selection criteria; and generating a second media content item from the number of media content items, the second media content item being an abbreviated version of the first media content item; and means for presenting the second media content item via a user interface.

In Example 18, the subject matter of Example 17 includes, wherein the content selection criteria comprises: selecting media content items based on a metric indicating an engagement level associated with each media content item; selecting media content items based on a measure of virality associated with each media content item; selecting media content items based on user interactions associated with each media content item; or, a combination thereof.

In Example 19, the subject matter of Examples 1-18 includes, wherein the content selection criteria comprises: selecting media content items to provide diversity in content types; selecting media content items to provide variety in subject matter depicted; selecting media content items based on user preferences; or a combination thereof.

In Example 20, the subject matter of Examples 1-19 includes, wherein the operations further comprise: receiving a selection to modify the second media content item; in response to receiving the selection, providing an interface for modifying the second media content item; receiving one or more modifications to the second media content item via the interface; generating a modified second media content item based on the one or more modifications; and presenting the modified second media content item via the user interface.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” and refers, for example, to a device accessed, controlled or owned by a user and with which the user interacts perform an action or interaction on the user device, including an interaction with other users or computer systems.

What is claimed is:

1. A system comprising:
at least one processor;
at least one memory storage device storing instructions thereon that, when executed by the at least one processor, cause the system to perform operations comprising:
receiving a first media content item comprising a plurality of media content items for sequential playback;
receiving a template corresponding with the first media content item, the template specifying at least i) a number of media content items to be selected from the plurality of media content items, and ii) content selection criteria for selecting the number of media content items from the plurality of media content items;
processing the template by:
selecting the number of media content items from the plurality of media content items in accordance with the content selection criteria; and
generating a second media content item from the number of media content items, the second media content item being an abbreviated version of the first media content item; and
presenting the second media content item via a user interface.

2. The system of claim 1, wherein the content selection criteria comprises:
selecting media content items based on a metric indicating an engagement level associated with each media content item;
selecting media content items based on a measure of virality associated with each media content item;
selecting media content items based on user interactions associated with each media content item; or,
a combination thereof.

3. The system of claim 1, wherein the content selection criteria comprises:
selecting media content items to provide diversity in content types;
selecting media content items to provide variety in subject matter depicted;
selecting media content items based on user preferences; or
a combination thereof.

4. The system of claim 1, wherein the operations further comprise:
receiving a selection to modify the second media content item;
in response to receiving the selection, providing an interface for modifying the second media content item;
receiving one or more modifications to the second media content item via the interface;
generating a modified second media content item based on the one or more modifications; and
presenting the modified second media content item via the user interface.

5. The system of claim 1, wherein selecting the number of media content items comprises:
inputting a video content item selected based on the content selection criteria into a machine learning model;
analyzing, by the machine learning model, the video content item to identify a segment of the video content item representing a highlight portion; and
extracting the identified highlight portion of the video content item as one of the number of media content items for inclusion in the second media content item.

6. The system of claim 5, wherein the machine learning model is trained to identify the highlight portion of a video content item by at least one of:
analyzing user engagement metrics associated with a plurality of video content items to determine segments with high engagement as highlights for training data;
receiving input identifying highlight segments in a plurality of video content items to generate training data; and
analyzing audiovisual features such as motion, speech, scene changes, facial expressions, or lighting in a plurality of video content items to determine highlight segments for training data.

7. The system of claim 1, wherein generating the second media content item comprises:
analyzing, by the processor, an audio track specified by the template to detect audio cues within the audio track;
determining time locations of the detected audio cues within the audio track;
analyzing each of the selected number of media content items to determine appropriate start and end times for presentation based on the time locations of the detected audio cues;
arranging the selected number of media content items according to the determined start and end times for each media content item to synchronize transitions between the selected number of media content items with the detected audio cues in the specified audio track; and
combining the arranged media content items with the specified audio track to generate the second media content item having synchronized transitions.

8. The system of claim 1, wherein the plurality of media content items were selected for the first media content item by:
receiving a first template specifying criteria for selecting the plurality of media content items;
analyzing a set of available media content items to identify a subset meeting the criteria of the first template; and
selecting the identified subset as the plurality of media content items that were included in the first media content item.

9. A method comprising:
receiving, by a processor, a first media content item comprising a plurality of media content items for sequential playback;
receiving, by the processor, a template corresponding with the first media content item, the template specifying at least i) a number of media content items to be selected from the plurality of media content items, and ii) content selection criteria for selecting the number of media content items from the plurality of media content items;
processing the template by:
selecting the number of media content items from the plurality of media content items in accordance with the content selection criteria; and
generating a second media content item from the number of media content items, the second media content item being an abbreviated version of the first media content item; and
presenting the second media content item via a user interface.

10. The method of claim 9, wherein the content selection criteria comprises:
selecting media content items based on a metric indicating an engagement level associated with each media content item;
selecting media content items based on a measure of virality associated with each media content item;
selecting media content items based on user interactions associated with each media content item; or,
a combination thereof.

11. The method of claim 9, wherein the content selection criteria comprises:
selecting media content items to provide diversity in content types;
selecting media content items to provide variety in subject matter depicted;
selecting media content items based on user preferences; or
a combination thereof.

12. The method of claim 9, further comprising:
receiving a selection to modify the second media content item;
in response to receiving the selection, providing an interface for modifying the second media content item;
receiving one or more modifications to the second media content item via the interface;
generating a modified second media content item based on the one or more modifications; and
presenting the modified second media content item via the user interface.

13. The method of claim 9, wherein selecting the number of media content items comprises:
inputting a video content item selected based on the content selection criteria into a machine learning model;
analyzing, by the machine learning model, the video content item to identify a segment of the video content item representing a highlight portion; and
extracting the identified highlight portion of the video content item as one of the number of media content items for inclusion in the second media content item.

14. The method of claim 13, wherein the machine learning model is trained to identify the highlight portion of a video content item by at least one of:
analyzing user engagement metrics associated with a plurality of video content items to determine segments with high engagement as highlights for training data;
receiving input identifying highlight segments in a plurality of video content items to generate training data; and
analyzing audiovisual features such as motion, speech, scene changes, facial expressions, or lighting in a plurality of video content items to determine highlight segments for training data.

15. The method of claim 9, wherein generating the second media content item comprises:
analyzing, by the processor, an audio track specified by the template to detect audio cues within the audio track;
determining time locations of the detected audio cues within the audio track;
analyzing each of the selected number of media content items to determine appropriate start and end times for presentation based on the time locations of the detected audio cues;
arranging the selected number of media content items according to the determined start and end times for each media content item to synchronize transitions between the selected number of media content items with the detected audio cues in the specified audio track; and
combining the arranged media content items with the specified audio track to generate the second media content item having synchronized transitions.

16. The method of claim 9, wherein the plurality of media content items were selected for the first media content item by:
receiving a first template specifying criteria for selecting the plurality of media content items;
analyzing a set of available media content items to identify a subset meeting the criteria of the first template; and
selecting the identified subset as the plurality of media content items that were included in the first media content item.

17. A system comprising:
means for receiving a first media content item comprising a plurality of media content items for sequential playback;
means for receiving a template corresponding with the first media content item, the template specifying at least i) a number of media content items to be selected from the plurality of media content items, and ii) content selection criteria for selecting the number of media content items from the plurality of media content items;
means for processing the template by:
selecting the number of media content items from the plurality of media content items in accordance with the content selection criteria; and
generating a second media content item from the number of media content items, the second media content item being an abbreviated version of the first media content item; and
means for presenting the second media content item via a user interface.

18. The system of claim 17, wherein the content selection criteria comprises:
selecting media content items based on a metric indicating an engagement level associated with each media content item;
selecting media content items based on a measure of virality associated with each media content item;
selecting media content items based on user interactions associated with each media content item; or,
a combination thereof.

19. The system of claim 1, wherein the content selection criteria comprises:
selecting media content items to provide diversity in content types;
selecting media content items to provide variety in subject matter depicted;
selecting media content items based on user preferences; or
a combination thereof.

20. The system of claim 1, wherein the operations further comprise:
receiving a selection to modify the second media content item;
in response to receiving the selection, providing an interface for modifying the second media content item;
receiving one or more modifications to the second media content item via the interface;
generating a modified second media content item based on the one or more modifications; and
presenting the modified second media content item via the user interface.
